(19) United States
(12) Patent Application Publication
(10) Pub. No.: US 2007/0055675 A1
(43) Pub. Date: Mar. 8, 2007

(54) INFORMATION PROCESSING DEVICE, CONTROL METHOD THEREFOR, DATA PROCESSING APPARATUS CONNECTABLE WITH INFORMATION PROCESSING DEVICE, AND PROGRAM FOR CAUSING COMPUTER TO EXECUTE THE CONTROL METHOD

(75) Inventor: Takaharu OOSAWA, Yokohama-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/469,760

(22) Filed: Sep. 1, 2006

(30) Foreign Application Priority Data
Sep. 2, 2005 (JP) 2005-255238

(51) Int. Cl. G06F 17/30

(52) U.S. Cl. 707/10

(57) ABSTRACT

An information processing device capable of determining, before installation of an application program in the information processing device or start of the program, whether operation of the application program is guaranteed for a data processing apparatus connected with the information processing device, thus preventing the application program from being used in combination with a data processing apparatus for which operation of the application program is not guaranteed. An application program having identification information of the program is received, and identification information for identifying a data processing apparatus is obtained from the apparatus to which the information processing device is connected. When these identification information match each other, use of the received application is permitted.

### BACKGROUND OF THE INVENTION

1. Field of the Invention

This invention relates to an information processing device, a control method therefor, a data processing apparatus to which an information processing device is connectable, and a program for causing a computer to execute the control method. More particularly, this invention relates to an information processing device connectable to a data processing apparatus such as a printing apparatus and capable of controlling the use of an externally received application program, a control method therefor, a data processing apparatus, and a program for causing a computer to execute the control method.

2. Description of the Related Art

There has been conventionally known an art to prevent unauthorized use of an application program installed in an information processing device, which is connectable to a data processing apparatus such as a printer and a multifunctional printer (see, for example, Japanese Laid-open Patent Publication (Kokai) No. 2005-038009). In the conventional art, when starting an installed application program, the information processing device (such as a network print server) compares license codes respectively stored in the data processing apparatus (such as a printer controller) and a main unit of the information processing device, and permits the application program to start only when the both license codes match each other. This makes it possible, to some extent, to prevent unauthorized use of the application program stored in the information processing device by an improper data processing apparatus which is connected to the information processing device.

With the conventional art, however, when an application program is installed in the information processing device, a license code is stored not only in the information processing device but also in the data processing apparatus to which the information processing device is mounted. In other words, the conventional art does not confirm, upon installation of an application program on the information processing device, whether or not proper operation of the application program is guaranteed for the data processing apparatus to which the information processing device is mounted. Therefore, upon installation of an application program in the information processing device, the license code can be stored even into a data processing apparatus for which the operation of the application program is not guaranteed.

Nevertheless, an application program can be started even for a data processing apparatus for which the operation of the application program is not guaranteed so long as a license code is stored in the data processing apparatus.

Therefore, according to the conventional art in which, when an application program is installed into the information processing device, a license code is stored even in a data processing apparatus for which a proper operation of the application program is not guaranteed, the application program can be started for such an improper data processing apparatus.

### SUMMARY OF THE INVENTION

It is an object of the present invention to provide an information processing device capable of determining, before the application program is installed in the information processing device or the application program is started, whether or not the operation of an application program is guaranteed for a data processing apparatus to which the information processing device is connected, thus preventing the application program from being used in combination with a data processing apparatus for which the operation of the application program is not guaranteed, as well as a control method for the information processing device, a data processing apparatus to which the information processing device is connectable, and a program for causing a computer to execute the control method.

To attain the above object, in a first aspect of the present invention, there is provided an information processing device connectable to a data processing apparatus, comprising a reception unit that receives an application program having a predetermined function and identification information corresponding to the application program, an identification information obtaining unit that obtains, from a data processing apparatus connected to the information processing device, identification information for identifying the data processing apparatus, and a control unit that permits use of the received application program in the information processing device when the identification information obtained by the identification information obtaining unit and the identification information received by the reception unit match each other.

Preferably, the control unit determines whether or not the identification information obtained by the identification information obtaining unit and the identifying information received by the reception unit match each other, prior to at least one of installation of the application program into the information processing device and start-up of the application program.

Preferably, the identification information is comprised of at least one of a device serial number and a name of the data processing apparatus.

Preferably, the information processing device further comprises an identification information determining unit that, when the reception unit receives pieces of identification information, determines whether or not the pieces of received identification information match pieces of identifying information obtained by the identification information obtaining unit from the data processing apparatus connected to the information processing device, and the control unit permits the use of the received application program in the information processing device when the pieces of received identification information match the pieces of obtained identification information.

Preferably, the control unit deletes the received application program when the identification information obtained by the identification information obtaining unit and the identification information received by the reception unit do not match each other.

Preferably, the control unit causes a message to be displayed which indicates that use of the application program is not permitted, when the identification information obtained by the identification information obtaining unit and the identification information received by the reception unit do not match each other.

Preferably, the application program having the predetermined function has a function of controlling the data processing apparatus and a function of controlling communication with another information processing device connected to a network.

To attain the above object, in a second aspect of the present invention, there is provided an information processing device connectable to a data processing apparatus, comprising a reception unit that receives an application program having a predetermined function and identification information corresponding to the application program, and a control unit that permits use of the received application program in the information processing device, when identification information for identifying the information processing device and the identification information received by the reception unit match each other.

To attain the above object, in a third aspect of the present invention, there is provided an information processing device connectable to a data processing apparatus, comprising a reception unit that receives an application program having a predetermined function and at least one piece of identification information corresponding to the application program, an identification information obtaining unit that obtains, from a data processing apparatus connected to the information processing device, identification information for identifying the data processing apparatus, a first identification information determining unit that determines whether or not the identification information obtained by the identification information obtaining unit and the identification information received by the reception unit match each other, a second identification information determining unit that determines whether or not identification information for identifying the information processing device and the identification information received by the reception unit match each other, and a control unit that permits use of the received application program in the information processing device according to a result of the determination by the first identification information determining unit when the reception unit receives identification information for identifying the data processing apparatus, permits the use of the received application program in the information processing device according to a result of the determination by the second identification information determining unit when the reception unit receives the identification information for identifying the information processing device, and permits the use of the received application program in the information processing device according to the results of the determinations by the first and second identification information determining units, when the reception unit receives the identification information for identifying the data processing apparatus and the identification information for identifying the information processing device.

To attain the above object, in a fourth aspect of the present invention, there is provided a control method for an information processing device connectable to a data processing apparatus, comprising: a reception step of receiving an application program having a predetermined function and identification information corresponding to the application program, an identification information obtaining step of obtaining, from a data processing apparatus connected to the information processing device, identification information for identifying the data processing apparatus to which the information processing device is connected, and a control step of permitting use of the received application program in the information processing device when the identification information obtained in the identification information obtaining step and the identification information received in the reception step match each other.

Preferably, the identification information is comprised of at least one of a device serial number and a name of the data processing apparatus.

Preferably, the control method further comprises an identification information determining step of, when pieces of identification information are received in the reception step, determining whether or not the pieces of received identification information match pieces of identification information obtained from the data processing apparatus connected to the information processing device in the identification information obtaining step, and wherein in the control step, the use of the received application program in the information processing device is permitted when the pieces of received identification information match the pieces of obtained identification information.

Preferably, in the control step, the received application program is deleted when the identification information obtained in the identification information obtaining step and the identification information received in the reception step do not match each other.

Preferably, in the control step, a message indicating that use of the application program is not permitted is caused to be displayed, when the identification information obtained in the identification information obtaining step and the identification information received in the reception step do not match each other.

Preferably, the application program having the predetermined function has a function of controlling the data processing apparatus and a function of controlling communication with another information processing device connected to a network.

To attain the above object, in a fifth aspect of the present invention, there is provided a data processing apparatus to which an information processing device is connectable and that communicates with another information processing device on a network via the connected information processing device, wherein the information processing device comprises a reception unit that receives an application program having a predetermined function and identification information corresponding to the application program, an identification information obtaining unit that obtains, from a data processing apparatus connected to the information processing device, identification information for identifying the data processing apparatus, and a control unit that permits use of the received application program in the information processing device when the identification information obtained by the identification information obtaining unit and the identification information received by the reception unit match each other.

To attain the above object, in a sixth aspect of the present invention, there is provided a computer readable program for causing a computer to execute a control method for an information processing device connectable to a data processing apparatus, comprising a reception module for receiving an application program having a predetermined function and identification information corresponding to the application program, an identification information obtaining module for obtaining, from a data processing apparatus connected to the information processing device, identification information for identifying the data processing apparatus, and a control module for permitting use of the received application program in the information processing device when the identification information obtained by the identification information obtaining module and the identification information received by the reception module match each other.

According to the present invention, when identification information obtained from a data processing apparatus to which the information processing device is connected matches identification information corresponding to an application program, control is performed so as to permit the use of the received application program in the information processing device. Consequently, even prior to the use of the application program, it is possible to determine whether or not the operation of the application program is guaranteed for the data processing apparatus to which the information processing device is connected, thereby preventing the application program from being used in combination with a data processing apparatus for which the operation of the application program is not guaranteed.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the hardware configuration of a printer to which a data processing apparatus according to a first embodiment of the present invention is applied.

FIG. 2 is a block diagram showing the software configuration of control programs stored in storage sections of a network print server and a printer controller shown in FIG. 1.

FIG. 3 is a view showing an example of a description of an application program operating on the network print server.

FIG. 4 is a flowchart showing the procedure of processes for installing an application program that is operable on the network print server.

FIG. 5 is a flowchart showing the procedure of processes for starting an application program that is operable on the network print server.

FIG. 6 is a flowchart showing the procedure of processes for installing an application program that is operable on a network print server in a second embodiment of the present invention.

FIG. 7 is a flowchart showing the procedure of processes for starting the operation of an application program that is operable on the network print server in the second embodiment.

FIG. 8 is a flowchart showing the procedure of processes for installing an application program that is to operate on a network print server in a third embodiment of the present invention.

FIG. 9 is part of a flowchart showing the procedure of processes for installing an application program that is operable on a network print server in a fourth embodiment of the present invention.

FIG. 10 is the remaining part of the flowchart showing the procedure of processes for installing an application program that is operable on the network print server in the fourth embodiment of the present invention.

FIG. 11 is a view showing an example of a license file.

FIG. 12 is a flowchart showing another example of the installation processes in FIG. 4.

### DETAILED DESCRIPTION OF THE PREFERRED EMBODIMENTS

The present invention will now be described in detail below with reference to the drawings showing preferred embodiments thereof.

### First Embodiment

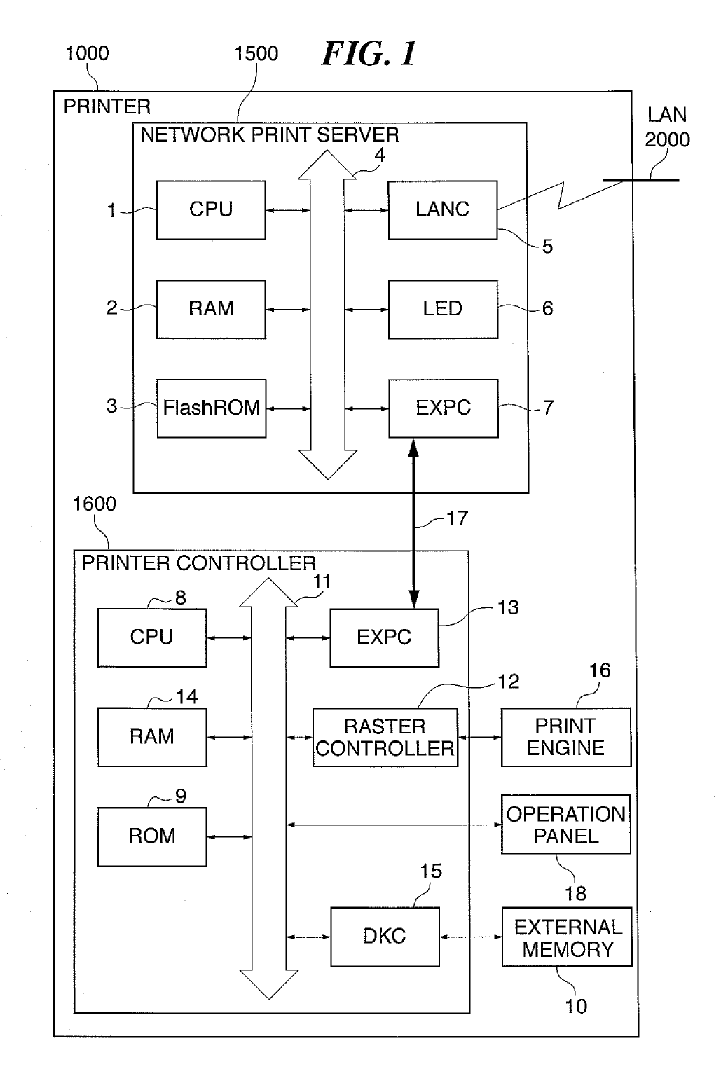

FIG. 1 is a block diagram showing the hardware configuration of a printer to which a data processing apparatus according to a first embodiment of the present invention is applied.

In FIG. 1, a printer 1000 to which the data processing apparatus of the present embodiment is applied is comprised of a network print server 1500 and a print controller 1600, each having an independent control system. The network print server 1500 is a network device realized in a form of an intelligent network card module and detachably mounted in the printer 1000. The printer controller 1600 controls a main unit of the printer 1000. The printer 1000 is comprised of an external memory 10 constituted by a hard disk or the like and connected to the printer controller 1600, a print engine 16 for printing, and an operation panel 18 (operation section).

The network print server 1500 is comprised of a CPU 1 for network print server, a RAM 2, and a flash ROM 3 which is a rewritable ROM. The network print server 1500 is further comprised of a network controller (LANC) 5, a LED 6, and an expansion interface controller (EXPC) 7, all of which are interconnected by a system bus 4.

The CPU 1 reads control programs stored in the flash ROM 3 to execute control processes. For example, by using a predetermined network communication protocol, the CPU 1 communicates with an external apparatus (not shown) such as a host computer connected to a local area network (LAN) 2000 via the LANC 5 connected to the system bus 4. Consequently, the CPU 1 performs overall control of transmission/reception of various kinds of information such as print data and printer control commands sent from the external apparatus, and appropriately controls data transfer to the printer controller 1600 connected thereto via the EXPC 7.

The RAM 2 is used as a main memory and a temporary memory area such as a work area of the CPU 1. The LED 6 is used as a display section showing an operation state of the network print server 1500. The LED 6 is capable of showing, for example, an electrical connection state (LINK) between the LANC 5 and the LAN 2000 and operation states such as network communication modes (10Base, 100Base, full duplex, half duplex), by colors and on/off patterns of the LED.

An expansion interface 17 connects the network print server 1500 and the printer controller 1600 and is provided with a not-shown connector. The network print server 1500 is detachably mounted to the printer 1000 (the printer controller 1600) via the connector. It should be noted that the network print server 1500 is mountable to other printers having the same configuration as the configuration of the printer 1000.

The printer controller 1600 is comprised of a CPU 8 for printer controller, a ROM 9, and a raster controller 12. The printer controller 1600 is further comprised of an expansion interface controller (EXPC) 13, a RAM 14, and a disk controller (DKC) 15, all of which are interconnected by a system bus 11.

The CPU 8 performs overall control of access to the devices connected to the system bus 11, based on, e.g., control programs stored in the ROM 9 or control programs and resource data (resource information) stored in the external memory 10 connected thereto via the DKC 15. Further, the CPU 8 causes the raster controller 12 to generate output image information based on print data received from the network print server 1500 via the EXPC 13 and to output an image signal to the print engine 16.

The RAM 14 functions as a main memory, a work area, and the like of the CPU 8. Further, a memory capacity of the RAM 14 can be expanded by an option RAM connected to an expansion port not shown. The operation panel 18 has buttons and a display section such as a liquid crystal panel or a LED. The buttons are operable by a user for, e.g., setting an operation mode and so on of the printer 1000 and canceling print data, and the display section shows an operation state of the printer 1000.

The print engine 16 is an image forming section utilizing a known print technology, and examples of a suitable printing method thereof are an electrophotographic method (laser beam method), an ink-jet method, and a sublimation (thermal transfer) method.

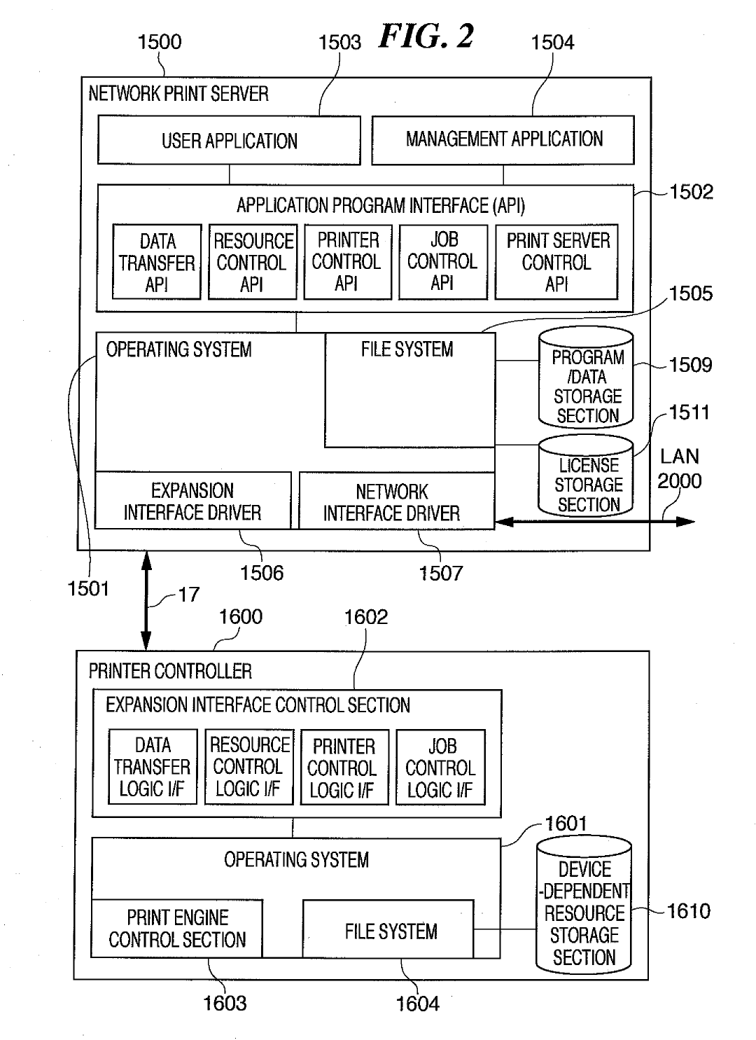

FIG. 2 is a block diagram showing the software configuration of control programs stored in the storage sections (for example, the flash ROM 3 and the ROM 9) of the network print server 1500 and the printer controller 1600 in FIG. 1. These control programs are executed by the aforesaid CPU 1 and CPU 8.

On the network print server 1500 side, an operating system (OS) 1501 performs overall control of input/output of basic data to and from the network print server 1500. The OS 1501 is comprised of a file system 1505, an expansion interface driver 1506, and a network interface driver 1507. The file system 1505 controls input/output from/to a program/data storage section 1509 and a license storage section 1511. The expansion interface driver 1506 controls communication with the printer controller 1600 via the expansion interface 17. The network interface driver 1507 communicates with an external apparatus (not shown) such as a host computer via a communication medium of the LAN 2000. Here, the program/data storage section 1509 and the license storage section 1511 are constituted by, for example, the flash ROM 3.

An application program interface (API) 1502 provides functions included in the OS 1501 to a user application 1503, a management application 1504, and so on operating in the network print server 1500. Here, the management application 1504 registers the user application 1503 in the printer 1000 and manages the user application 1503.

The program/data storage section 1509 stores application programs received from an external apparatus such as a host computer. The license storage section 1511 stores license files (license information), which are inputted when the application programs are installed, in correspondence to the respective application programs.

The API 1502 has, as functions provided to the application programs, a data transfer API providing a function of transmitting/receiving print data and a resource control API controlling input/output of resource data such as bit map images and display messages. The API 1502 further has a printer control API controlling, e.g., the restart of the printer 1000 and the initialization and setting of set values for the printer 1000, and a job control API controlling, e.g., the cancellation and re-print instruction of a print job. Further, the API 1502 has a print server control API that controls the restart of the network print server 1500, the initialization and setting of set values for the network print server 1500, the operation start (start-up), registration, and deletion of application programs.

On the printer controller 1600 side, an operating system (OS) 1601 performs overall control of processes of the printer controller 1600. The OS 1601 is comprised of a print engine control section 1603 and a file system 1604 controlling input/output from/to a device-dependent resource storage section 1610. The print engine control section 1603 controls communication with the print engine 16. The device-dependent resource storage section 1610 stores, e.g., device-dependent resources such as bit map image data and error messages which are referred to from the network print server 1500. Here, the device-dependent resource storage section 1610 is constituted by, for example, the ROM 9 and the external memory 10. Information on a device serial number and a device name of the printer 1000 (the printer controller 1600) are stored in the device-dependent resource storage section 1610.

An expansion interface control section 1602 controls communication with the network print server 1500 via the expansion interface 17. The expansion interface control section 1602 is comprised of a data transfer logic interface (I/F), a resource control logic interface (I/F), a printer control logic interface (I/F), and a job control logic interface (I/F). The data transfer logic interface (I/F) controls input/output of print data on a type of control basis. The resource control logic interface (I/F) controls input/output of the data stored in the device-dependent resource storage section 1610. The printer control logic interface (I/F) controls, e.g., the restart of the printer 1000 and the initialization and setting of set values for the printer 1000. The job control logic interface (I/F) controls, e.g., the cancellation of and re-print instruction for a print job. The expansion interface control section 1602 transfers commands requested from the network print server 1500 to the operating system 1601 via the logic interfaces and sends back processing results thereof to the network print server 1500.

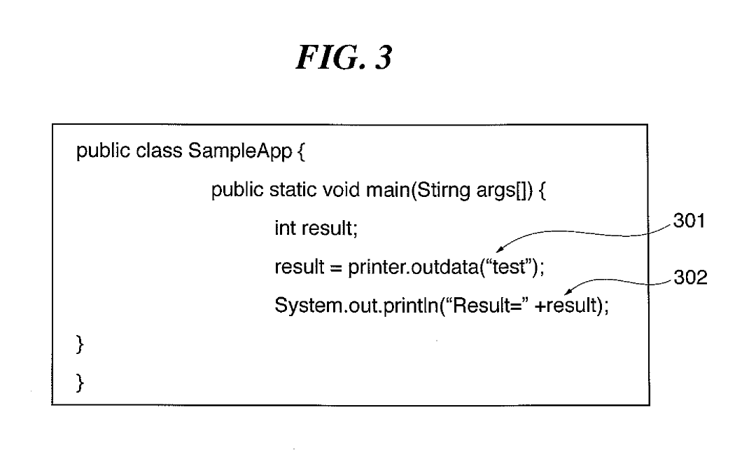

FIG. 3 is a view showing an example of a description of an application program operating on the network print server 1500. FIG. 3 shows an example of a description in Java (registered trademark) language as a suitable example of the present invention.

In FIG. 3, a line 301 is a description for calling the data transfer API shown in FIG. 2. In the line 301, “printer.outdata (“test”) represents the data transfer API. This is a printer-controller-dependent command indicating that text data “test” should be printed as print data from the print engine via the printer controller. When the command is executed in the printer controller 1600, the processing result is converted into a numeric type variable “result” in a line 302.

The line 302 is an example of a description of a command for transmitting the result of the processing instructed in the line 301 to a standard output destination and converting the result to a text message for display. Examples of the standard output destination are the LCD display section (not shown) on the operation panel 18 of the printer 1000, and a browser display section (not shown) of a host computer being a calling end of the application.

Next, a description will be given of the installation of an application program that is to operate on the network print server 1500.

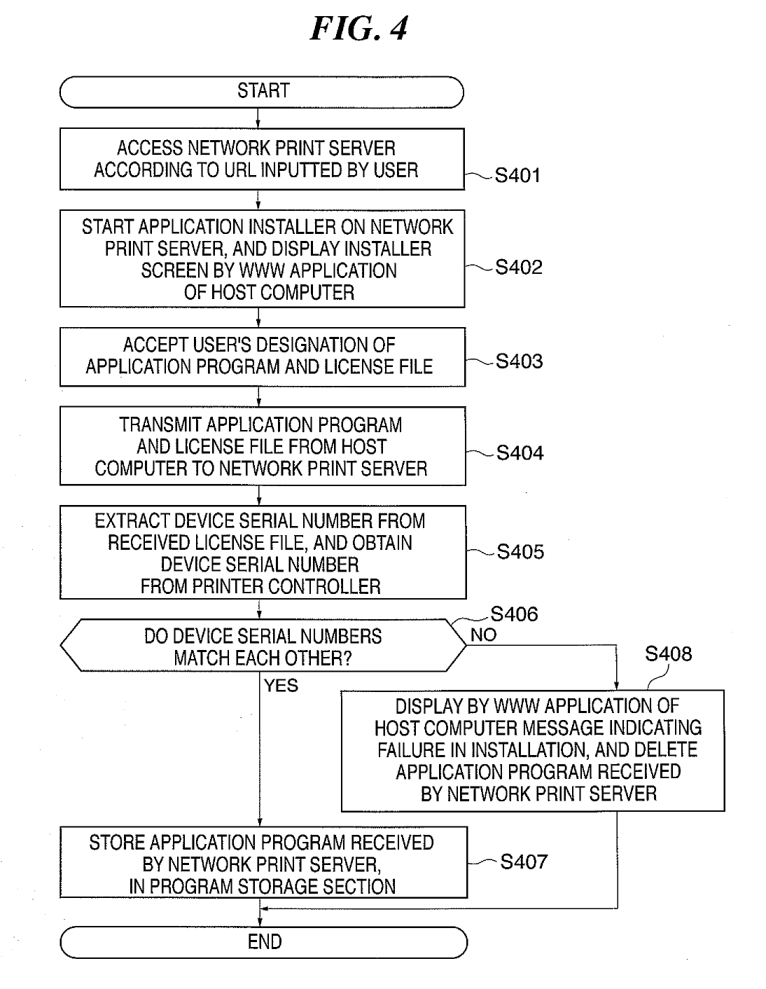

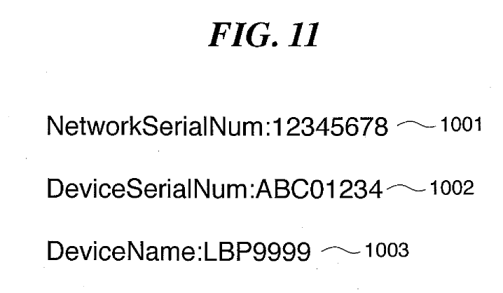

FIG. 4 is a flowchart showing the procedure of processes for installing an application program that is for use on the network print server 1500. FIG. 4 shows an example where whether the installation of an application program is to be permitted is determined based on a device serial number of the printer 1000 (the printer controller 1600) to which the network print server 1500 is mounted. A series of the installation processes executed by a host computer and the network print server 1500 is shown in FIG. 4. An example of the device serial number is shown in FIG. 11 by the reference numeral 1002.

In FIG. 4, first, a user starts a WWW application on the host computer and inputs a URL (Uniform Resource Locator) of an application installer operating on the network print server 1500. In a step S401, the host computer accesses the network print server 1500 according to the URL inputted by the user.

Next, in a step S402, the network print server 1500 accessed by the host computer starts the application installer. Then, the network print server 1500 transmits, to the host computer, data based on which the WWW application of the host computer displays an application program installer screen.

Next, on the installer screen, the user designates an application program to be installed and a license file thereof. In a step S403, the host computer accepts the designation of the application program and the license file. Further, in a step S404, in response to a user's pressing of an “OK” button on the screen, the host computer transmits the application program and the license file to the network print server 1500.

Next, in a step S405, from the license file received together with the application program from the host computer, the network print server 1500 extracts a device serial number designated in the license file. At the same time, the network print server 1500 obtains the device serial number of the printer 1000 (the printer controller 1600) from the printer controller 1600.

Next, in a step S406, the network print server 1500 compares the device serial number extracted from the license file and the device serial number obtained from the printer controller 1600. As a result of the comparison, if the two device serial numbers do not match each other, the process proceeds to a step S408. On the other hand, if the two device serial numbers match each other, the process proceeds to a step S407.

In the step S407, the network print server 1500 stores the received application program in the program/data storage section 1509 and stores the license file in the license storage section 1511, and the present processes are terminated.

In the step S408, the network print server 1500 transmits, to the host computer, data based on which the WWW application of the host computer displays a message indicating a failure in installing the application program. Further, the network print server 1500 deletes the received application program and license file, and the present processes are terminated.

By the present processes, before an application program is installed from the host computer via the LAN 2000, it is possible to determine whether or not the operation of the application program is guaranteed for the printer 1000. It is also possible to prevent the application program from being used in combination with a printer for which the operation of the application program is not guaranteed.

Next, processes for starting the operation (start-up) of an application program that is operable on the network print server 1500 will be described.

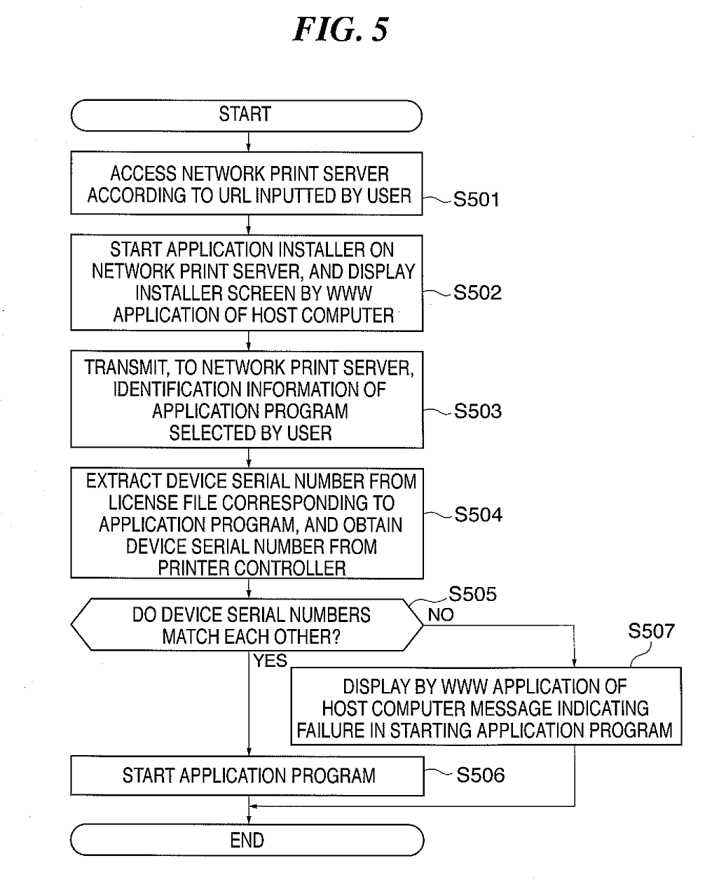

FIG. 5 is a flowchart showing the procedure of the processes for starting the operation of an application program for use on the network print server 1500. FIG. 5 shows an example where whether the operation start of the application program is to be permitted is determined based on the device serial number of the printer 1000 (the printer controller 1600) to which the network print server 1500 is mounted. A series of the operation start processes executed by the host computer and the network print server 1500 are shown FIG. 5.

In FIG. 5, first, a user starts the WWW application on the host computer and inputs a URL of an application installer operating on the network print server 1500. In a step S501, the host computer accesses the network print server 1500 according to the URL inputted by the user.

Next, in a step S502, the network print server 1500 accessed by the host computer starts the application installer. Then, the network print server 1500 transmits, to the host computer, data based on which the WWW application of the host computer displays an application program installer screen.

On the installer screen, the user selects a required one of application programs already installed in the network print server 1500, and presses a “start” button for starting the operation of the application program. Then, in a step S503, the host computer transmits, to the network print server 1500, information for identifying the application program selected by the user.

In a step S504, the network print server 1500 receives the information for identifying the application program from the host computer. Then, the network print server 1500 reads, from the license storage section 1511, a license file corresponding to the application program identified by the received information. Then, the network print server 1500 extracts a device serial number designated in the read license file and also obtains the device serial number of the printer 1000 from the printer controller 1600.

Subsequently, in a step S505, the network print server 1500 compares the device serial number extracted from the license file and the device serial number obtained from the printer controller 1600. As a result of the comparison, if the two device serial numbers do not match each other, the process proceeds to a step S507. On the other hand, if the two device serial numbers match each other, the process proceeds to a step S506.

In the step S506, the network print server 1500 starts the operation of the application program selected by the user, and the present processes are terminated.

In the step S507, the network print server 1500 transmits, to the host computer, data based on which the WWW application of the host computer displays a message indicating a failure in starting the application program, and the present processes are terminated.

By the present processes, before an application program stored in the program/data storage section 1509 is started, it is possible to determine whether or not the operation of the application program is guaranteed for the printer 1000. In addition, it is possible to prevent the application program from being used in combination with a printer for which the operation of the application program is not guaranteed.

According to the first embodiment described above, before an application program is installed or started on the network printer server 1500 mounted to the printer 1000, a device serial number is extracted from a license file that is received together with the application program or stored in correspondence to the application program. Then, the network print server 1500 determines whether or not the extracted device serial number and the device serial number obtained from the printer controller 1600 of the printer 1000 match each other. Consequently, it is possible to determine, prior to the installation or start-up of the application program, whether or not the operation of the application program is guaranteed for the printer 1000. It is also possible to prevent the application program from being used in combination with a printer for which the operation of the application program is not guaranteed.

Furthermore, in the combination of the printer 1000 and the network printer server 1500, it is possible to perform control so as not to allow the start-up if no proper application program is installed. Therefore, in a case where the network print server 1500 on which no proper application program is installed is mounted to another printer 1000, it is possible to prevent the start of an application program that should not be started in such a case.

Furthermore, in a case where a user changes only a network print server without changing a printer, an application program used in the previously used network print server can be used also in a new network print server.

The above first embodiment has described the example where a device serial number is designated in a license file, but it should be noted that this is not restrictive, and for example, a device serial number may be designated in an application program.

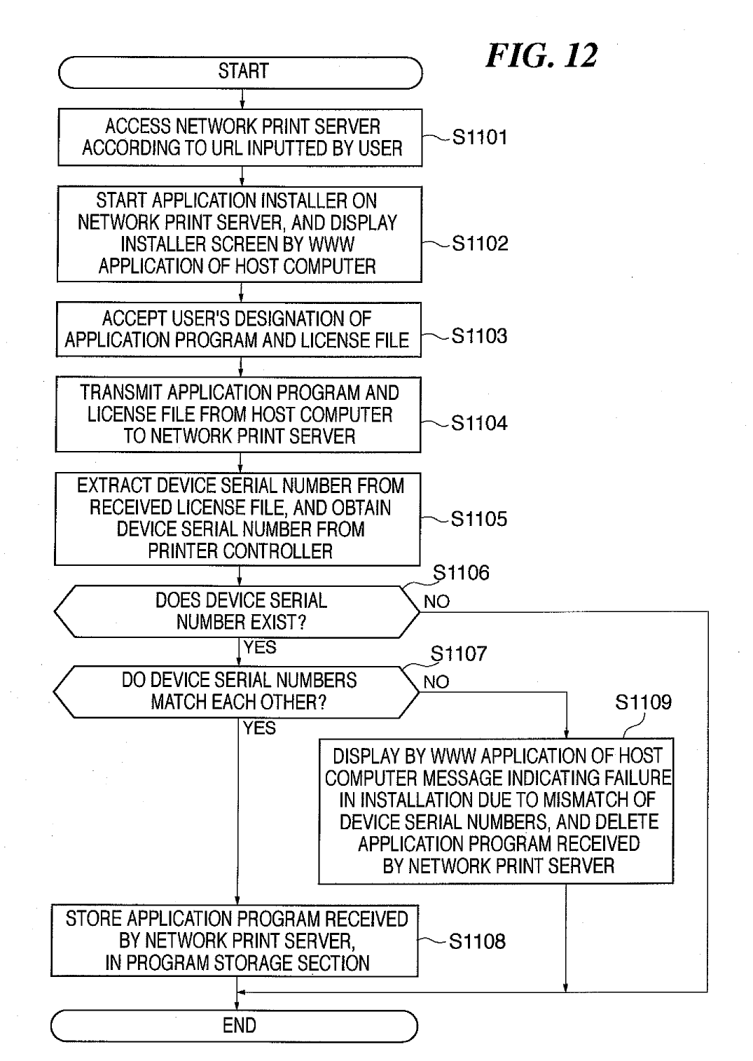

Furthermore, in the program installation processes in FIG. 4, it is assumed that a device serial number is designated in a license file, but a determination process to determine presence or absence of a device serial number in a license file may be added. For example, in FIG. 12, a process for determining whether or not a device serial number exists in the license file is added as a step S1106 to the processes in FIG. 4. The steps S401 to S405 and steps S1101 to S1105 in FIG. 12 are the same processes, and the steps S406 to S408 in FIG. 4 and steps S1107 to S1109 in FIG. 12 are the same processes.

In FIG. 12, in the step S1106, the network print server 1500 determines whether or not a device serial number exists in the license file. As a result of the determination, if the device serial number does not exist, the network print server 1500 cancels the installation, and the present processes are terminated. On the other hand, if the device serial number exists, the process proceeds to the step S1107.

In the step S1107, the network print server 1500 compares the device serial number extracted from the license file and the device serial number obtained from the printer controller 1600. As a result of the comparison, if the two device serial numbers match each other, the process proceeds to the step S1108. On the other hand, if the two device serial numbers do not match each other, the process proceeds to the step S1109.

In the step S1108, the network print server 1500 stores the application program received from the host computer in the program/data storage section 1509. Further, the network print server 1500 stores the license file in the license storage section 1511, and the present processes are terminated.

In the step S1109, the network print server 1500 transmits, to the host computer, data based on which the WWW application of the host computer displays a message indicating a failure in installing the application program. Then, the network print server 1500 deletes the received application program and license file, and the present processes are terminated.

By the present processes, it is possible to provide the same effects as those of the first embodiment described above and moreover, the processes can be efficiently executed even in a case where a license file not including a device serial number is received.

### Second Embodiment

The configuration of a data processing apparatus according to a second embodiment of the present invention is the same as that of the printer 1000 in the first embodiment described above (FIGS. 1 and 2), and therefore, a description thereof will be omitted. Only what are different from the above-described first embodiment will be described below.

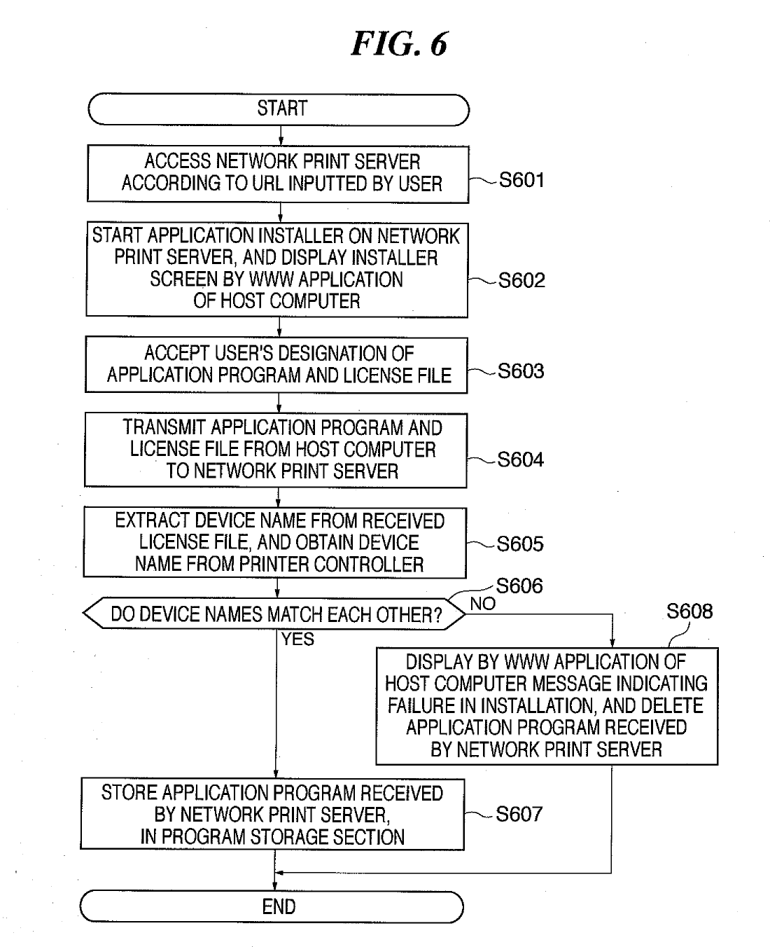

FIG. 6 is a flowchart showing the procedure of processes for installing an application program that is for use on a network print server 1500 in the second embodiment of the present invention. FIG. 6 shows an example where whether or not the installation of an application program received from a host computer is to be permitted is determined based on a device name of the printer 1000 to which the network print server 1500 is mounted. An example of the device name is shown in FIG. 11 by the reference numeral 1003. A series of the installation processes executed by the host computer and the network print server 1500 are shown in FIG. 6.

In FIG. 6, first, a user starts a WWW application on the host computer and inputs a URL of an application installer operating on the network print server 1500. In a step S601, the host computer accesses the network print server 1500 according to the URL inputted by the user.

Next, in a step S602, the network print server 1500 accessed by the host computer starts the application installer. Then, the network print server 1500 transmits, to the host computer, data based on which the WWW application of the host computer displays an application program installer screen.

Next, on the installer screen, the user designates an application program to be installed and a license file thereof. In a step S603, the host computer accepts the designation of the application program and the license file. Further, in a step S604, in response to a user's pressing of an “OK” button on the screen, the host computer transmits the application program and the license file to the network print server 1500.

Next, in a step S605, the network print server 1500 extracts a device name from the license file received from the host computer and also obtains the device name of the printer 1000 from a printer controller 1600.

Next, in a step S606, the network print server 1500 compares the device name extracted from the license file and the device name obtained from the printer controller 1600. As a result of the comparison, if the two device names do not match each other, the process proceeds to a step S608. On the other hand, if the two device names match each other, the process proceeds to a step S607.

In the step S607, the network print server 1500 stores the received application program in a program/data storage section 1509 and also stores the received license file in a license storage section 1511, and the present processes are terminated.

In the step S608, the network print server 1500 transmits, to the host computer, data based on which the WWW application of the host computer displays a message indicating a failure in installing the application program. Further, the network print server 1500 deletes the received application program and license file, and the present processes are terminated.

By the present processes, before an application program is installed from the host computer via a LAN 2000, it is possible to determine whether or not the operation of the application program is guaranteed for the printer 1000. Further, it is possible to prevent the application program from being used in combination with a printer for which the operation of the application program is not guaranteed.

Next, processes for starting the operation of an application program that is operable on the network print server 1500 will be described.

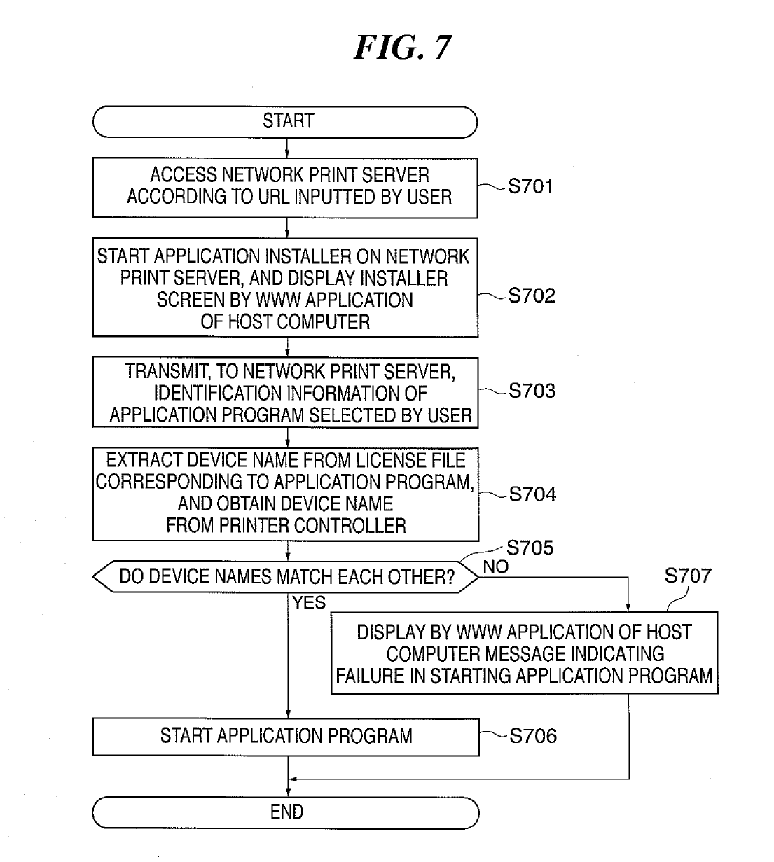

FIG. 7 is a flowchart showing the procedure of the processes for starting the operation of an application program that is for use on the network print server 1500 in the second embodiment. FIG. 7 shows an example where whether or not the start of the operation of an application program stored in the program/data storage section 1509 is to be permitted is determined based on the device name of the printer 1000 to which the network print server 1500 is mounted. A series of the operation start processes executed by the host computer and the network print server 1500 are shown in FIG. 7.

In FIG. 7, first, a user starts the WWW application on the host computer and inputs a URL of an application installer operating on the network print server 1500. In a step S701, the host computer accesses the network print server 1500 according to the URL inputted by the user.

Next, in a step S702, the network print server 1500 accessed by the host computer starts the application installer. Then, the network print server 1500 transmits, to the host computer, data based on which the WWW application of the host computer displays an application program installer screen.

Next, on the installer screen, the user selects a required one of application programs installed in the network print server 1500 and presses a button (not shown) for starting the operation of the application program. Then, in a step S703, the host computer transmits, to the network print server 1500, information for identifying the application program selected by the user.

In a step S704, the network print server 1500 reads, from the license storage section 1511, a license file corresponding to the application program identified by the received information. Then, the network print server 1500 extracts a device name from the read license file and also obtains the device name of the printer 1000 from the printer controller 1600.

Subsequently, in a step S705, the network print server 1500 compares the device name extracted from the license file and the device name obtained from the printer controller 1600. As a result of the comparison, if the two device names do not match each other, the process proceeds to a step S707. On the other hand, if the two device names mach each other, the process proceeds to a step S706.

In the step S706, the network print server 1500 starts the operation of the application program selected by the user, and the present processes are terminated.

In the step S707, the network print server 1500 transmits, to the host computer, data based on which the WWW application of the host computer displays a message indicating a failure in starting the application program, and the present processes are terminated.

By the present processes, prior to the start of an application program stored in the program/data storage section 1509, it is possible to determine whether or not the operation of the application program is guaranteed for the printer 1000. Therefore, it is possible to prevent the application program from being used in combination with a printer for which the operation of the application program is not guaranteed.

According to the second embodiment described above, before an application program is installed or started on the network printer server 1500 mounted to the printer 1000, a device name is extracted from a license file received together with the application program or stored in correspondence to the application program. Then, the network print server 1500 determines whether or not the extracted device name and the device name obtained from the printer controller 1600 of the printer 1000 match each other. Consequently, it is possible to determine, prior to the installation or start of the application program, whether or not the operation of the application program is guaranteed for the printer 1000. Furthermore, it is possible to prevent the application program from being used in combination with a printer for which the operation of the application program is not guaranteed.

Furthermore, in the combination of the printer 1000 and the network printer server 1500, it is possible to perform control so as not to allow the start-up if no proper application program is installed. Therefore, in a case where the network print server 1500 on which no proper application program is installed is mounted to another printer 1000, it is possible to prevent the start of an application program that should not be started in such a case.

Furthermore, in a case where a user changes only a network print server without changing a printer, an application program used in the previously used network print server can be used also in a new network print server.

Furthermore, even when a user changes a printer, an application program can be used in a new printer if the previously used printer and a new printer have the same device name.

The above second embodiment has described the example where a device name is designated in a license file, but it should be noted that this is not restrictive. For example, a device name may be designated in an application program.

### Third Embodiment

The configuration of a data processing apparatus according to a third embodiment of the present invention is the same as that of the printer 1000 in the first embodiment described above (FIGS. 1 and 2), and therefore, a description thereof will be omitted. Only what are different from the above-described first embodiment will be described below.

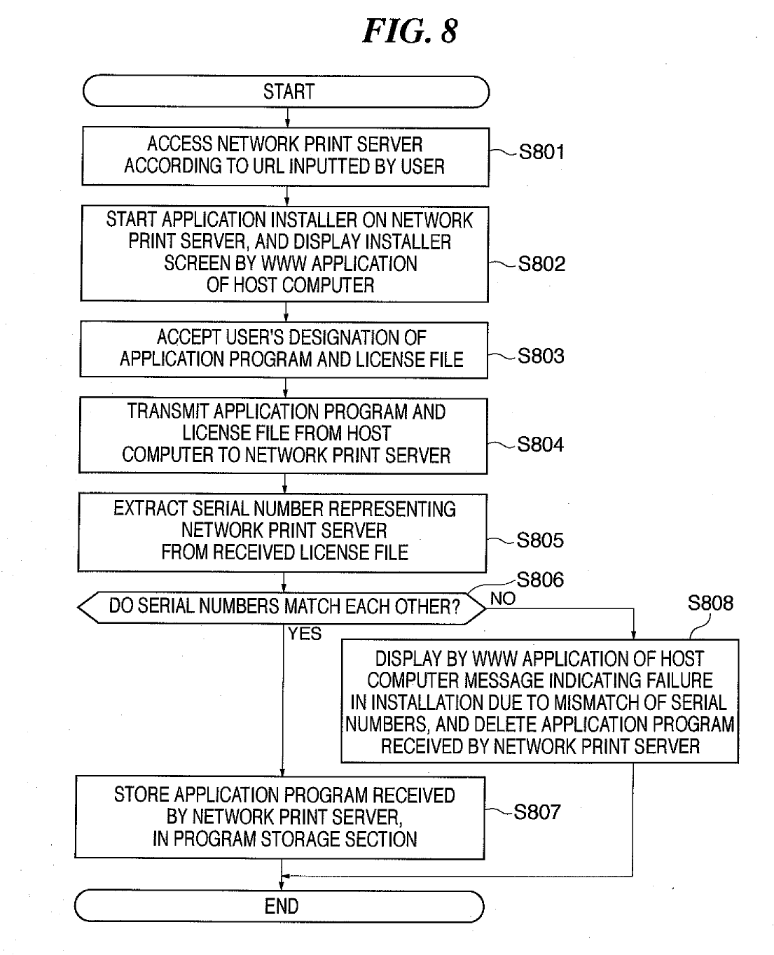

FIG. 8 is a flowchart showing the procedure of processes for installing an application program that is for use on a network print server 1500 in the third embodiment of the present invention. FIG. 8 shows an example where whether or not the installation of an application program received from a host computer is to be permitted is determined based on a serial number of the network print server 1500. An example of the serial number of the network print server 1500 is shown in FIG. 11 by the reference numeral 1001. A series of the installation processes executed by the host computer and the network print server 1500 are shown in FIG. 8.

In FIG. 8, first, a user starts a WWW application on the host computer and inputs a URL of an application installer operating on the network print server 1500. In a step S801, the host computer accesses the network print server 1500 according to the URL inputted by the user.

Next, in a step S802, the network print server 1500 accessed by the host computer starts the application installer. Then, the network print server 1500 transmits, to the host computer, data based on which the WWW application of the host computer displays an application program installer screen.

Next, on the installer screen, the user designates an application program to be installed and a license file thereof. In a step S803, the host computer accepts the designation of the application program and the license file. Further, in a step S804, in response to a user's pressing of an “OK” button on the screen, the host computer transmits the application program and the license file to the network print server 1500.

Next, in a step S805, the network print server 1500 extracts a serial number from the license file that has been received together with the application program from the host computer. Further, the network print server 1500 obtains the serial number of the network printer server 1500 itself from a flash ROM 3 or the like

Next, in a step S806, the network print server 1500 compares the serial number extracted from the license file and the serial number of the network print server 1500 itself. As a result of the comparison, if the two serial numbers do not match each other, the process proceeds to a step S808. On the other hand, if the two serial numbers match each other, the process proceeds to a step S807.

In the step S807, the network print server 1500 stores the received application program in a program/data storage section 1509 and also stores the received license file in a license storage section 1511, and the present processes are terminated.

In the step S808, the network print server 1500 transmits, to the host computer, data based on which the WWW application of the host computer displays a message indicating a failure in installing the application program. Further, the network print server 1500 deletes the received application program and license file, and the present processes are terminated.

According to the third embodiment described above, before an application program is installed on the network print server 1500 from the host computer via a LAN 2000, the network printer server 1500 extracts a serial number from a license file. Further, the network print server 1500 determines whether or not the extracted serial number and the serial number of the network print server 1500 match each other. Consequently, it is possible to determine, prior to the installation of the application program, whether or not the operation of the application program is guaranteed for the network print server 1500. Further, it is possible to prevent the application program from being used in combination with a network print server for which the operation of the application program is not guaranteed.

Furthermore, even when a user changes only a printer without changing a network print server, an application program previously used in the network print server is usable in a new printer.

The above third embodiment has described the example where a serial number is designated in a license file, but it should be noted that this is not restrictive. For example, a serial number may he designated in an application program.

Furthermore, similarly to the first and second embodiments described above, before starting an application program, it may be determined whether or not a serial number extracted from a license file and the serial number of the network print server 1500 match each other. It goes without saying that the effects of the present invention in the first and second embodiments described above can be obtained as a result.

### Fourth Embodiment

The configuration of a data processing apparatus according to a fourth embodiment of the present invention is the same as that of the printer 1000 in the first embodiment described above (FIGS. 1 and 2), and therefore, a description thereof will be omitted. Only what are different from the above-described first embodiment will be described below.

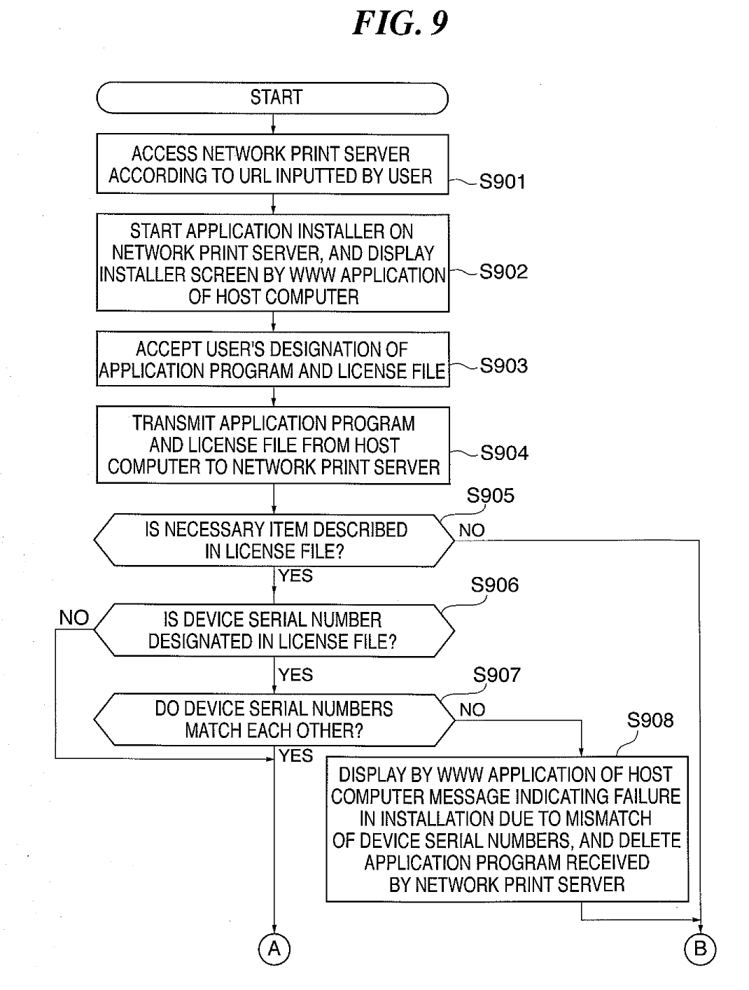

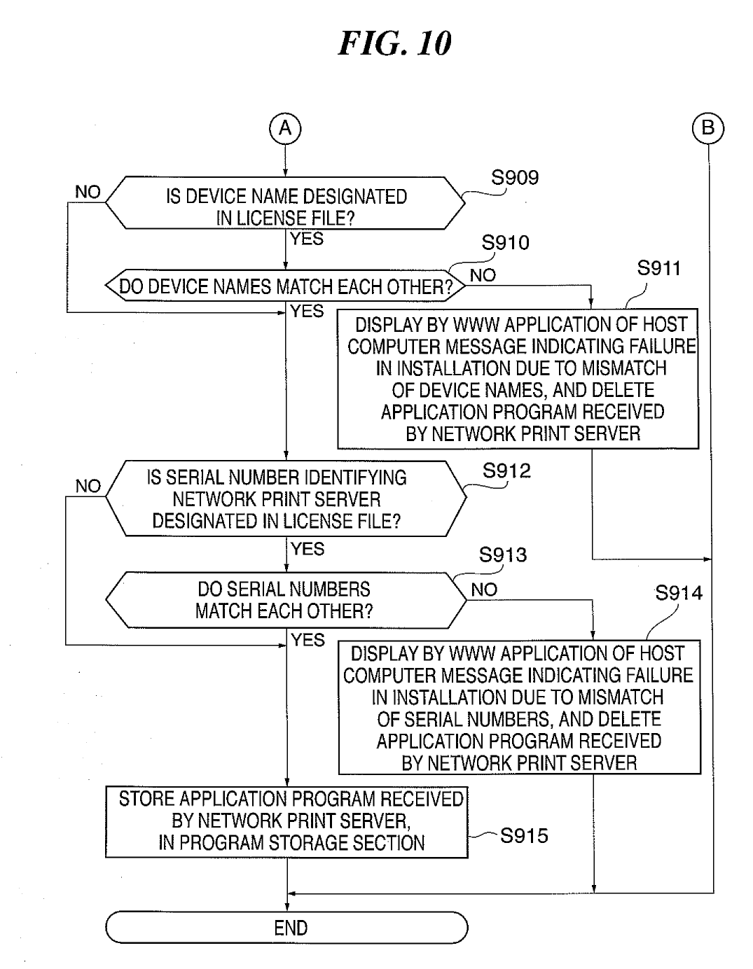

FIGS. 9 and 10 are flowcharts showing the procedure of processes for installing an application program that is for use on a network print server 1500 in the fourth embodiment of the present invention. FIGS. 9 and 10 show an example where whether or not the installation of an application program is to be permitted is determined based on the presence or absence of a device serial number and a device name of the printer 1000 (a printer controller 1600) and a serial number of the network print server 1500. A series of the installation processes executed by a host computer and the network print server 1500 is shown in FIGS. 9 and 10.

In FIG. 9, first, a user starts a WWW application on the host computer and inputs a URL of an application installer operating on the network print server 1500. In a step S901, the host computer accesses the network print server 1500 according to the URL inputted by the user.

Next, in a step S902, the network print server 1500 accessed by the host computer starts the application installer. Then, the network print server 1500 transmits, to the host computer, data based on which the WWW application of the host computer displays an application program installer screen.

Next, on the installer screen, the user designates an application program to be installed and a license file thereof. In a step S903, the host computer accepts the designation of the application program and the license file. Further, in a step S904, in response to a user's pressing of an “OK” button on the screen, the host computer transmits the application program and the license file to the network print server 1500.

In a step S905, the network print server 1500 determines whether or not an item necessary for installing the application program is described in the license file received from the host computer. The necessary item is information such as a device serial number, a device name, or a serial number of a network print server. As a result of the determination in the step S905, if the necessary item is not described, the network print server 1500 determines that the installation cannot be permitted and cancels the installation, and the present processes are terminated. On the other hand, if the necessary item exists, the process proceeds to a step S906.

In the step S906, the network print server 1500 determines whether or not a device serial number is designated in the license file. As a result of the determination, if the device serial number is not designated, the process proceeds to a step S909. On the other hand, if the device serial number is designated, the process proceeds to a step S907.

In the step S907, the network print server 1500 determines whether or not the designated serial number and the device serial number of the printer 1000 (the printer controller 1600) match each other. As a result of the determination, if the two device serial numbers match each other, the process proceeds to the step S909. On the other hand, if the two device serial numbers do not match each other, the process proceeds to a step S908.

In the step S908, the network print server 1500 causes the WWW application of the host computer to display a message indicating a failure in installing the application program due to the mismatch of the device serial numbers. For this purpose, the network print server 1500 transmits, to the host computer, data based on which the WWW application of the host computer displays this message. Further, the network print server 1500 deletes the received application program and license file, and the present processes are terminated.

In the step S909, the network print server 1500 determines whether or not a device name is designated in the license file. As a result of the determination, if the device name is not designated, the process proceeds to a step S912. On the other hand, if the device name is designated, the process proceeds to a step S910.

In the step S910, the network print server 1500 determines whether or not the designated device name and the device name of the printer 1000 (printer controller 1600) match each other. As a result of the determination, if the device names match each other, the process proceeds to the step S912. On the other hand, if the device names do not match each other, the process proceeds to a step S911.

In the step S911, the network print server 1500 causes the WWW application of the host computer to display a message indicating a failure in installing the application program due to the mismatch of the device names. For this purpose, the network print server 1500 transmits, to the host computer, data based on which the WWW application of the host computer displays this message. Further, the network print server 1500 deletes the received application program and license file, and the present processes are terminated.

In the step S912, the network print server 1500 determines whether or not a serial number of a network print server is designated in the license file. As a result of the determination, if the serial number is not designated, the process proceeds to a step S915. On the other hand, if the serial number is designated, the process proceeds to a step S913.

In the step S913, the network print server 1500 determines whether or not the designated serial number and the serial number of the network print server 1500 itself match each other. As a result of the determination, if the serial numbers match each other, the process proceeds to the step S915. On the other hand, if the serial numbers do not match each other, the process proceeds to a step S914.

In the step S914, the network print server 1500 causes the WWW application of the host computer to display a message indicating a failure in installing the application program due to the mismatch of the serial numbers. For this purpose, the network print server 1500 transmits, to the host computer, data based on which the WWW application of the host computer displays this message. Further, the network print server 1500 deletes the received application program and license file, and the present processes are terminated.

In the step S915, the network print server 1500 stores the application program received from the host computer in a program/data storage section 1509. At the same time, the network print server 1500 stores the license file in a license storage section 1511, and the present processes are terminated.

According to the fourth embodiment described above, the network print server 1500 mounted to the printer 1000 determines the following before an application program is installed from the host computer via a LAN 2000. That is, the network print server 1500 determines whether or not a device serial number and so on designated in a license file match the device serial number and so on of the printer 1000 (the print controller 1600) respectively. Since the application program is installed based on the determination result, it is possible to determine, prior to the installation of the application program, whether or not the operation of the application program is guaranteed for the printer 1000. Furthermore, it is possible to prevent the application program from being used in a printer for which the operation of the application program is not guaranteed.

When providing an application program, a provider of the application program can select which one of a device serial number, a device name, and a serial number of a network print server is to be designated in a license file. Therefore, the provider of the application program can variably determine the kind of a license of an application program on an application program basis and can freely select a method of restricting the start and the installation of the application program.

The above fourth embodiment has described the example where a device serial number and so on are designated in a license file, but it should be noted that this is not restrictive. For example, a device serial number and so on may be designated in an application program.

The object of the present invention may also be accomplished by supplying a system or an apparatus with a storage medium in which a program code of software, which realizes the functions of either of the above-described embodiments, is stored. In this case, a computer (a CPU, an MPU, or the like) of the system or the apparatus reads the program code stored in the storage medium to execute the program code.

In this case the program code itself read from the storage medium realizes the functions of either of the above-described embodiments, and hence the storage medium on which the program code is stored constitutes the present invention.

Examples of the storage medium for supplying the program code include a floppy (registered trademark) disk, a hard disk, and a magnetic-optical disk. Further, optical disks such as a CD-ROM, a CD-R, a CD-RW, a DVD-ROM, a DVD±R, a DVD-RAM, and a DVD±RW, a magnetic tape, a nonvolatile memory card, and the like are usable. Alternatively, the program code may be downloaded via a network.

Further, the program code read out from the storage medium is written into a memory provided in an expansion board inserted into a computer or provided in an expansion unit connected to the computer. It is to be understood that the functions of either of the above-described embodiments may be accomplished by thereafter causing a CPU or the like provided in the expansion board or the expansion unit to perform a part or all of the actual operations based on instructions of the program code.

Further, the functions of either of the above-described embodiments may be accomplished not only by executing the program code read out by a computer, but also by causing an OS or the like which operates on the computer to perform a part or all of the actual operations based on instructions of the program code. It goes without saying this case is also included in the present invention.

In this case, the aforesaid program is supplied directly from the storage medium storing the program or by downloading from another computer, a database, or the like, not shown, connected to the Internet, a commercial network, a local area network, or the like.

The above embodiments have described the examples where a printing method of the printer 1000 is an electrophotographic method, but the present invention is applicable not only to the electrophotographic method but to various kinds of printing methods such as an ink-jet method, a thermal transfer method, a thermography method, an electrostatic method, and a discharge breakdown method.

The form of the program may be an object code, a program code executed by an interpreter, or script data supplied to an OS (operating system).

This application claims priority from Japanese Patent Application No. 2005-255238, filed Sep. 2, 2005, which is hereby incorporated by reference herein.

What is claimed is:

1. An information processing device connectable to a data processing apparatus, comprising:
a reception unit that receives an application program having a predetermined function and identification information corresponding to the application program;
an identification information obtaining unit that obtains, from a data processing apparatus connected to the information processing device, identification information for identifying the data processing apparatus; and
a control unit that permits use of the received application program in the information processing device when the identification information obtained by said identification information obtaining unit and the identification information received by said reception unit match each other.

2. An information processing device according to claim 1, wherein said control unit determines whether or not the identification information obtained by said identification information obtaining unit and the identifying information received by said reception unit match each other, prior to at least one of installation of the application program into the information processing device and start-up of the application program.

3. An information processing device according to claim 1, wherein the identification information is comprised of at least one of a device serial number and a name of the data processing apparatus.

4. An information processing device according to claim 1, further comprising:
an identification information determining unit that, when said reception unit receives pieces of identification information, determines whether or not the pieces of received identification information match pieces of identifying information obtained by said identification information obtaining unit from the data processing apparatus connected to the information processing device,
wherein said control unit permits the use of the received application program in the information processing device when the pieces of received identification information match the pieces of obtained identification information.

5. An information processing device according to claim 1, wherein said control unit deletes the received application program when the identification information obtained by said identification information obtaining unit and the identification information received by said reception unit do not match each other.

6. An information processing device according to claim 1, wherein said control unit causes a message to be displayed which indicates that use of the application program is not permitted, when the identification information obtained by said identification information obtaining unit and the identification information received by said reception unit do not match each other.

7. An information processing device according to claim 1, wherein the application program having the predetermined function has a function of controlling the data processing apparatus and a function of controlling communication with another information processing device connected to a network.

8. An information processing device connectable to a data processing apparatus, comprising:
a reception unit that receives an application program having a predetermined function and identification information corresponding to the application program; and
a control unit that permits use of the received application program in the information processing device, when identification information for identifying the information processing device and the identification information received by said reception unit match each other.

9. An information processing device connectable to a data processing apparatus, comprising:
a reception unit that receives an application program having a predetermined function and at least one piece of identification information corresponding to the application program;
an identification information obtaining unit that obtains, from a data processing apparatus connected to the information processing device, identification information for identifying the data processing apparatus;
a first identification information determining unit that determines whether or not the identification information obtained by said identification information obtaining unit and the identification information received by said reception unit match each other;
a second identification information determining unit that determines whether or not identification information for identifying the information processing device and the identification information received by said reception unit match each other; and
a control unit that permits use of the received application program in the information processing device according to a result of the determination by said first identification information determining unit when said reception unit receives identification information for identifying the data processing apparatus, permits the use of the received application program in the information processing device according to a result of the determination by said second identification information determining unit when said reception unit receives the identification information for identifying the information processing device, and permits the use of the received application program in the information processing device according to the results of the determinations by said first and second identification information determining units, when said reception unit receives the identification information for identifying the data processing apparatus and the identification information for identifying the information processing device.

10. A control method for an information processing device connectable to a data processing apparatus, comprising:
a reception step of receiving an application program having a predetermined function and identification information corresponding to the application program;
an identification information obtaining step of obtaining, from a data processing apparatus connected to the information processing device, identification information for identifying the data processing apparatus to which the information processing device is connected; and
a control step of permitting use of the received application program in the information processing device when the identification information obtained in said identification information obtaining step and the identification information received in said reception step match each other.

11. A control method according to claim 10, wherein the identification information is comprised of at least one of a device serial number and a name of the data processing apparatus.

12. A control method according to claim 10, further comprising:
an identification information determining step of, when pieces of identification information are received in said reception step, determining whether or not the pieces of received identification information match pieces of identification information obtained from the data processing apparatus connected to the information processing device in said identification information obtaining step,
wherein in said control step, the use of the received application program in the information processing device is permitted when the pieces of received identification information match the pieces of obtained identification information.

13. A control method according to claim 10, wherein in said control step, the received application program is deleted when the identification information obtained in said identification information obtaining step and the identification information received in said reception step do not match each other.

14. A control method according to claim 10, wherein in said control step, a message indicating that use of the application program is not permitted is caused to be displayed, when the identification information obtained in said identification information obtaining step and the identification information received in said reception step do not match each other.

15. A control method according to claim 10, wherein the application program having the predetermined function has a function of controlling the data processing apparatus and a function of controlling communication with another information processing device connected to a network.

16. A data processing apparatus to which an information processing device is connectable and that communicates with another information processing device on a network via the connected information processing device,
wherein the information processing device comprises:
a reception unit that receives an application program having a predetermined function and identification information corresponding to the application program;
an identification information obtaining unit that obtains, from a data processing apparatus connected to the information processing device, identification information for identifying the data processing apparatus; and
a control unit that permits use of the received application program in the information processing device when the identification information obtained by said identification information obtaining unit and the identification information received by said reception unit match each other.

17. A computer readable program for causing a computer to execute a control method for an information processing device connectable to a data processing apparatus, comprising:
a reception module for receiving an application program having a predetermined function and identification information corresponding to the application program;
an identification information obtaining module for obtaining, from a data processing apparatus connected to the information processing device, identification information for identifying the data processing apparatus; and
a control module for permitting use of the received application program in the information processing device when the identification information obtained by said identification information obtaining module and the identification information received by said reception module match each other.
